(19) United States
(12) Patent Application Publication
(10) Pub. No.: US 2014/0317127 A1
(43) Pub. Date: Oct. 23, 2014

(54) METHOD AND APPARATUS FOR CONSTRUCTING ONTOLOGY FOR DIALOGUE SYSTEM

(71) Applicant: POSTECH ACADEMY - INDUSTRY FOUNDATION, Gyeongbuk (KR)

(72) Inventors: Geun Bae LEE, Gyeongsangbuk-do (KR); Dong Hyeon LEE, Gyeongsangnam-do (KR); Jun Hwi CHOI, Gyeongsangbuk-do (KR); Yong Hee KIM, Seoul (KR); Seong Han RYU, Seoul (KR); Sang Jun KOO, Seoul (KR)

(73) Assignee: POSTECH ACADEMY - INDUSTRY FOUNDATION, Gyeongbuk (KR)

(21) Appl. No.: 14/255,070

(22) Filed: Apr. 17, 2014

(30) Foreign Application Priority Data
Apr. 18, 2013 (KR) 10-2013-0042709

(51) Int. Cl. G06F 17/30

(52) U.S. Cl. CPC G06F 17/30734
USPC 707/749

(57) ABSTRACT

Provided are a method and an apparatus for constructing an ontology for a dialogue system. The method for constructing an ontology for a dialogue system includes: generating a domain ontology plane based on intra-plane relation information of a domain defining a relationship between a plurality of domain nodes; generating a main act ontology plane based on intra-plane relation information of a main act defining a relationship between a plurality of main act nodes; and generating an entity name ontology plane based on intra-plane relation information of an entity name defining a relationship between a plurality of entity name nodes. Therefore, it is possible to construct multiple ontology planes and discriminate components of dialogue frames such as a domain, a main act and an entity name. Also, an effective system response can be performed by discriminating dialogue frames exactly using the multi ontology planes.

### CLAIM FOR PRIORITY

This application claims priority to Korean Patent Application No. 10-2013-0042709 filed on Apr. 18, 2013 in the Korean Intellectual Property Office (KIPO), the entire contents of which are hereby incorporated by reference.

### BACKGROUND

1. Technical Field

Example embodiments of the present invention relate in general to a dialogue system, and more specifically, to a method and an apparatus for constructing an ontology for a natural language dialogue system.

2. Related Art

A dialogue system means an apparatus providing necessary information to user through dialogues using voice or text. Also, a range of uses of the dialogue system is expanding to a next generation intelligent interface for apparatuses such as a terminal, a vehicle, a robot, etc.

In recent years, the interest in natural language dialogue processing software is increasing because of a supply expansion of mobile devices such as a smartphone.

FIG. 1 is a block diagram illustrating a configuration of a natural language dialogue system. Referring to FIG. 1, the natural language dialogue system 10 comprises a variety of components for processing a dialogue.

First, the natural language dialogue system 10 comprises a natural language understanding (NLU) unit 11 transforming a natural language text into a dialogue frame which can be understood by the system, a dialogue management (DM) unit 12 predicting a system action to be performed actually on the system based on the dialogue frame, and managing strategically a next dialogue to be performed, and a task management (TM) unit 13 performing appropriate processes according to the predicted action and providing a system response.

Each of the components has necessary capabilities for performing the appropriate processes, which are learned from dialogue corpus. However, it is difficult to manage learned information because the capabilities used in each of the components may have redundancy according to the component managing the capabilities.

### SUMMARY

Accordingly, example embodiments of the present invention are provided to substantially obviate one or more problems due to limitations and disadvantages of the related art.

Example embodiments of the present invention provide a method for constructing an ontology for a dialogue system.

Example embodiments of the present invention also provide an apparatus for constructing an ontology for a dialogue system.

In some example embodiments, a method for constructing an ontology for a dialogue system may include: generating a domain ontology plane based on intra-plane relation information of a domain defining a relationship between a plurality of domain nodes; generating a main act ontology plane based on intra-plane relation information of a main act defining a relationship between a plurality of main act nodes; and generating an entity name ontology plane based on intra-plane relation information of an entity name defining a relationship between a plurality of entity name nodes.

Also, the method for constructing an ontology for a dialogue system may further include constructing an inter-plane relation based on inter-plane relation information defining a relationship between the domain ontology plane, the main act ontology plane and the entity name ontology plane.

Here, in the generating of a domain ontology plane, the domain ontology plane may be generated based on the intra-plane relation information of a domain comprising at least one transition probability information of a domain node, use keywords similarity information of a domain node and layer information of a domain node, which can define a relationship between the plurality of domain nodes.

Here, in the generating of a main act ontology plane, the main act ontology plane may be generated based on the intra-plane relation information of a main act comprising at least one transition probability information of a main act node, use keywords similarity information of a main act node and performance order information of a main act node, which can define a relationship between the plurality of main act nodes.

Here, in the generating of an entity name ontology plane, the entity name ontology plane may be generated based on the intra-plane relation information of an entity name comprising at least one transition probability information of an entity name node, use keywords similarity information of an entity name node and simultaneous entrance probability information of an entity name node, which can define a relationship between the plurality of entity name nodes.

In other example embodiments, an apparatus for constructing an ontology for a dialogue system may include: a domain management unit configured to manage a domain ontology plane generated based on intra-plane relation information of a domain defining a relationship between a plurality of domain nodes; a main act management unit configured to manage a main act ontology plane generated based on intra-plane relation information of a main act defining a relationship between a plurality of main act nodes; and an entity name management unit configured to manage an entity name ontology plane generated based on intra-plane relation information of an entity name defining a relationship between a plurality of entity name nodes.

Also, the apparatus for constructing an ontology for a dialogue system may further include an inter-plane relation management unit configured to construct an inter-plane relation based on inter-plane relation information defining a relationship between the domain ontology plane, the main act ontology plane and the entity name ontology plane.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a conventional natural language dialogue system;

FIG. 2 is a conceptual view for describing a relationship between nodes according to an example embodiment of the present invention;

FIG. 3 is a conceptual view for describing multiple ontology planes according to an example embodiment of the present invention;

FIG. 4 is an exemplary illustration for describing a domain ontology plane according to an example embodiment of present invention;

FIG. 5 is an exemplary illustration for describing a main act ontology plane according to an example embodiment of present invention;

FIG. 6 is an exemplary illustration for describing an entity name ontology plane according to an example embodiment of present invention;

FIG. 7 is an exemplary illustration for describing an inter-plane relation according to an example embodiment of present invention;

FIG. 8 is a flowchart illustrating a method for constructing an ontology for a dialogue system according to an example embodiment of the present invention; and

FIG. 9 is a block diagram illustrating an apparatus for constructing an ontology for a dialogue system according to an example embodiment of the present invention.

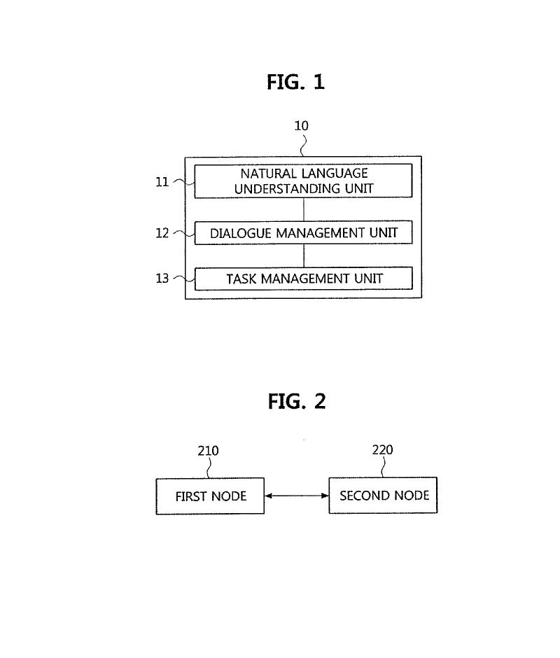

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings.

FIG. 2 is a conceptual view for describing a relationship between nodes according to an example embodiment of the present invention.

First, with regard to a natural language dialogue system, some terms used in the application will be described as follows.

A natural language text received as an input is transformed to a dialogue frame, which can be understood by a system, may comprise concepts such as a domain, a main act, an entity name, etc.

The ‘domain’ may mean a field or a category which can be processed in a dialogue system. For example, the domain can be classified into fields such as weather, a television (TV), a schedule management, etc. However, the present invention is not limited by a specific classification standard or method for the domain.

The ‘main act’ may mean a behavior performed in a specific domain. For example, in the domain for the TV, the main act may be one of an act of changing channel, an act of searching program start time, etc.

The ‘entity name’ may mean a name of a subject or an object for the main act. In other words, the entity name may define the behavior which is performed actually by the main act. For example, in the domain for the TV, the entity name can be a name of an actor, a title of a channel, a title of a program, etc.

A ‘node’ may mean data comprising information about the domain, the main act and the entity name respectively. Also, the node may be classified into a domain node, a main act node and an entity name node. That is, the node may comprise information about the node and a relationship between the node and other nodes.

The domain node may comprise information about the domain corresponding to the domain node and a relationship between the domain node and other nodes. Also, the main act node may comprise information about the main act corresponding to the main act node and a relationship between the main act node and other nodes. Also, the entity name node may comprise information about the entity name corresponding to the entity name node and a relationship between the entity name node and other nodes.

Referring to FIG. 2, a relationship between nodes may be described. In FIG. 2, a first node 210 or a second node 220 may mean a domain node, a main act node or an entity name node.

The relationship between at least one node may be defined according to example embodiments of the present invention. Nodes may belong to a same ontology plane or different ontology planes. Here, the ontology may mean concepts in a specific field as a data model representing the specific field, and a set of formal words describing a relationship between the concepts. Also, the ontology plane may be a concept comprising a plurality of nodes classified by the standard set in advance.

The first node 110 and the second node 120 may be connected based on information about their mutual relations. Also, the information about their mutual relations may mean probability information calculated statistically.

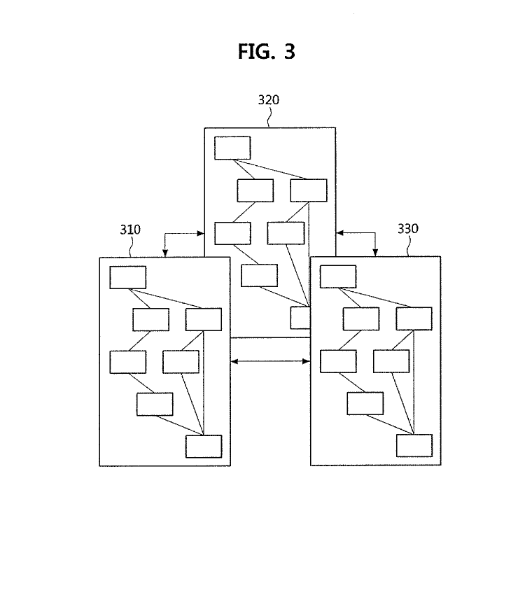

FIG. 3 is a conceptual view for describing multiple ontology planes according to an embodiment of the present invention.

Referring to FIG. 3, according to an example embodiment of the present invention, multiple ontology planes for a dialogue system may be constructed. Also, an ontology plane may be classified into a domain ontology plane 310, a main act ontology plane 320 and an entity name ontology plane 330.

The domain ontology plane 310 may be generated based on intra-plane relation information of a domain defining a relationship between a plurality of domain nodes. The main act ontology plane 320 may be generated based on intra-plane relation information of a main act defining a relationship between a plurality of main act nodes. Also, the entity name ontology plane 330 may be generated based on intra-plane relation information of an entity name defining a relationship between a plurality of entity name nodes.

In other words, connections between a plurality of domain nodes may constitute the domain ontology plane 310. Connections between a plurality of main act nodes may constitute the main act ontology plane 320. Connections between a plurality of entity name nodes may constitute the entity name ontology plane 330.

Meanwhile, the intra-plane relation information may mean information about a relationship in the same plane, and more specifically, information about a relationship between nodes in the same plane.

Also, the inter-plane relation information may mean information about a relationship between different planes and, more specifically, information about a relationship between nodes in different planes.

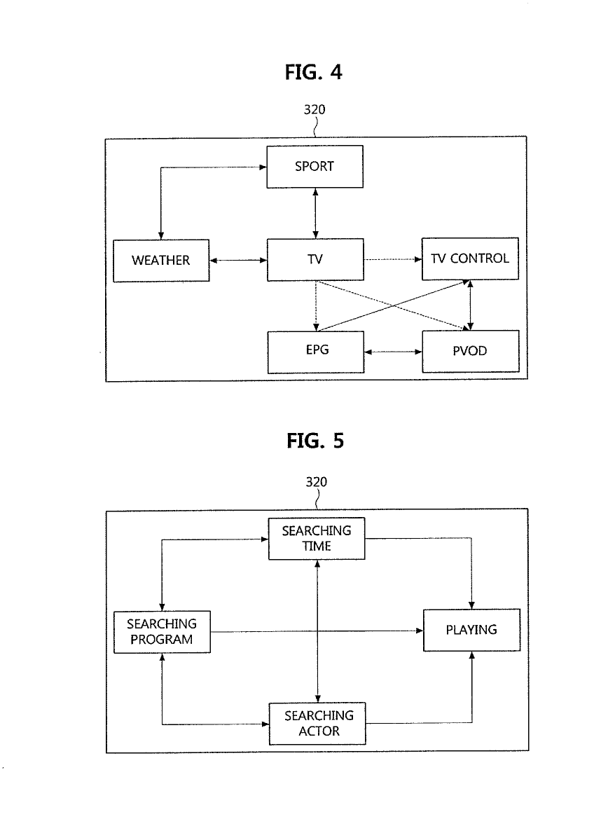

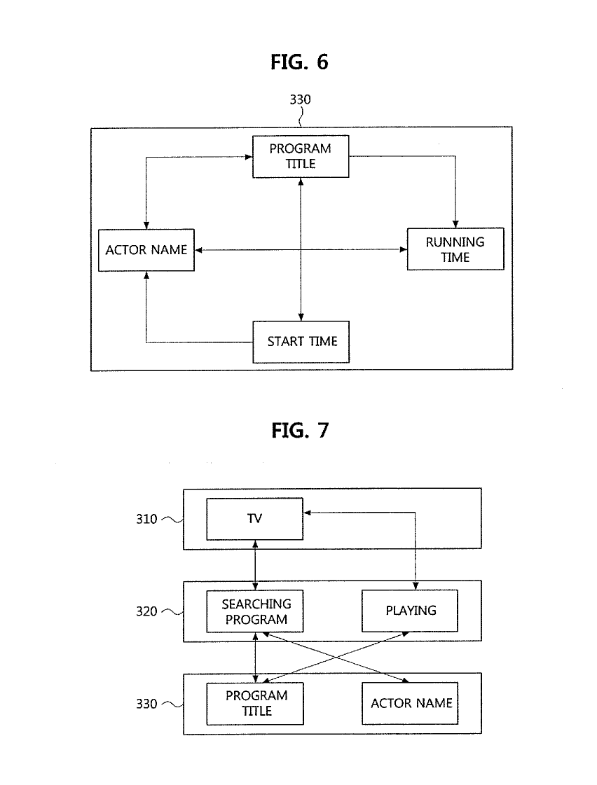

FIG. 4 is an exemplary illustration for describing a domain ontology plane according to an example embodiment of present invention, FIG. 5 is an exemplary illustration for describing a main act ontology plane according to an example embodiment of present invention, and FIG. 6 is an exemplary illustration for describing an entity name ontology plane according to an example embodiment of present invention.

Referring to FIG. 4, a domain ontology plane 310 according to an example embodiment of the present invention is described as follows.

For example, the domain ontology plane 310 may comprise domain nodes for domains such as sport, weather, TV, Electric Program Guide (EPG), Push Video On Demand (PVOD), TV control, etc. Also, each domain node may be connected based on intra-plane relation information of a domain.

Meanwhile, the intra-plane relation information of a domain may comprise transition probability information of a domain node, use keywords similarity information of a domain node, layer information of a domain node, etc.

The transition probability information of a domain node may mean information about probability for transition from one domain node to another domain node. The use keywords similarity information of a domain node may mean information about concordance rates between keywords used in one domain node and another domain node.

Also, the layer information of a domain node may be defined as hierarchical relations between nodes. For example, domain nodes for Electric Program Guide (EPG), Push Video On Demand (PVOD) and TV control may be defined as lower concept than the domain node for TV.

Referring to FIG. 5, a main act ontology plane 320 according to an example embodiment of the present invention is described as follows.

For example, the main act ontology plane 320 may comprise main act nodes for main acts such as searching time, searching program, playing, searching actor, etc. Also, each main act node may be connected based on intra-plane relation information of a main act.

Meanwhile, the intra-plane relation information of a main act node may comprise transition probability information of a main act node, use keywords similarity information of a main act node, performance order information of a main act node, etc.

The transition probability information of a main act node may mean information about probability for transition from one main act node to another main act node. The use keywords similarity information of a main act node may mean information about concordance rates between keywords used in one main act node and in another main act node.

Also, the performance order information of a main act node may mean information about performance order for a main act, which can be calculated statistically.

Referring to FIG. 6, an entity name ontology plane 330 according to an example embodiment of the present invention is described as follows.

For example, the entity name ontology plane 330 may comprise entity name nodes for entity names such as a title of a program, a name of an actor, running time, start time, etc. Also, each entity name node may be connected based on intra-plane relation information of an entity name.

Meanwhile, the intra-plane relation information of an entity name may comprise transition probability information of an entity name node, use keywords similarity information of an entity name node, simultaneous entrance probability information of an entity name node, etc.

The transition probability information of an entity name node may mean information about probability for transition from one entity name node to another entity name node. The use keywords similarity information of an entity name node may mean information about concordance rates between keywords used in one entity name node and in another entity name node.

Also, the simultaneous entrance probability information of an entity name node may mean information about probability for entity names which can enter simultaneously in one sentence.

FIG. 7 is an exemplary illustration for describing an inter-plane relation according to an example embodiment of present invention.

Referring to FIG. 7, ontology planes according to an example embodiment of present invention may comprise a domain ontology plane 310, a main act ontology plane 320 and an entity name ontology plane 330. Also, mutual relations between ontology planes may be defined as inter-plane relation.

Inter-plane relation information may define mutual relations between the domain ontology plane 310, the main act ontology plane 320 and the entity name ontology plane 330. In other words, the inter-plane relation information can define mutual relations between nodes in the respective ontology plane.

For example, the inter-plane relation information may comprise inter-plane probability information indicating mutual relations between a plurality of domain nodes, a plurality of main act nodes and a plurality of entity name nodes.

Meanwhile, the inter-plane probability information may mean information calculated statistically based on an associative relationship between ontology planes. For example, the inter-plane probability information may mean information about probability to perform a specific main act in a specific domain, and to present a specific entity name for performance of a specific main act.

Shown as FIG. 7, a domain node for TV may construct the inter-plane relation with main act nodes for acts of searching program and playing. Also, main act nodes for searching program and playing may construct the inter-plane relation with entity name nodes for a title of a program and a name of an actor.

Therefore, according to an example embodiment of present invention, the inter-plane relation may be constructed based on the inter-plane relation information.

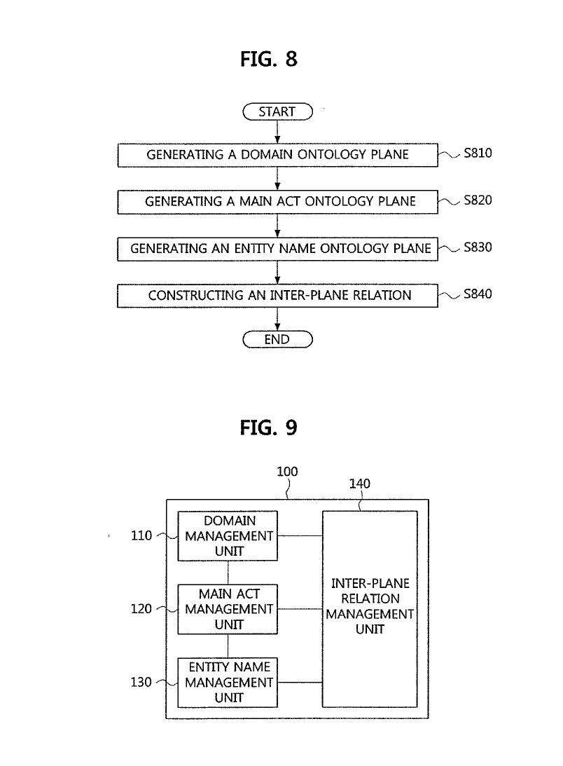

FIG. 8 is a flowchart illustrating a method for constructing an ontology for a dialogue system according to an example embodiment of the present invention.

Referring to FIG. 8, a method for constructing an ontology for a dialogue system according to an example embodiment of the present invention may include: generating a domain ontology plane (S810); generating a main act ontology plane (S820); and generating an entity name ontology plane (S830). Also, the method may further include constructing an inter-plane relation (S840).

In step S810, the domain ontology plane 310 may be generated based on intra-plane relation information of a domain defining a relationship between a plurality of domain nodes. The domain ontology plane 310 may be generated based on the intra-plane relation information of a domain comprising at least one transition probability information of a domain node, use keywords similarity information of a domain node and layer information of a domain node, which can define a relationship between a plurality of domain nodes.

In step S820, the main act ontology plane 320 may be generated based on intra-plane relation information of a main act defining a relationship between a plurality of main act nodes. The main act ontology plane 320 may be generated based on the intra-plane relation information of a main act comprising at least one transition probability information of a main act node, use keywords similarity information of a main act node and performance order information of a main act node, which can define a relationship between a plurality of main act nodes.

In step S830, the entity name ontology plane 330 may be generated based on intra-plane relation information of an entity name defining a relationship between a plurality of entity name nodes. The entity name ontology plane 330 may be generated based on the intra-plane relation information of an entity name comprising at least one transition probability information of an entity name node, use keywords similarity information of an entity name node and simultaneous entrance probability information of an entity name node, which can define a relationship between the plurality of entity name nodes.

In step S840, the inter-plane relation may be constructed based on inter-plane relation information defining a relationship between the domain ontology plane 310, the main act ontology plane 320 and the entity name ontology plane 330.

For example, the inter-plane relation may be constructed based on the inter-plane relation information comprising inter-plane probability information indicating mutual relations between a plurality of domain nodes, a plurality of main act nodes and a plurality of entity name nodes.

FIG. 9 is a block diagram illustrating an apparatus for constructing an ontology for a dialogue system according to an example embodiment of the present invention.

Referring to FIG. 9, an apparatus 100 for constructing an ontology for a dialogue system according to an example embodiment of the present invention may include a domain management unit 110, a main act management unit 120, an entity name management unit 130 and an inter-plane relation management unit 140.

The domain management unit 110 may manage a domain ontology plane 310 generated based on intra-plane relation information of a domain defining a relationship between a plurality of domain nodes. The domain management unit 110 may manage the domain ontology plane 310 based on the intra-plane relation information of a domain comprising at least one transition probability information of a domain node, use keywords similarity information of a domain node and layer information of a domain node, which can define a relationship between a plurality of domain nodes.

The main act management unit 120 may manage a main act ontology plane 320 generated based on intra-plane relation information of a main act defining a relationship between a plurality of main act nodes. The main act management unit 120 may manage the main act ontology plane 320 based on the intra-plane relation information of a main act comprising at least one transition probability information of a main act node, use keywords similarity information of a main act node and performance order information of a main act node, which can define a relationship between a plurality of main act nodes.

The entity name management unit 130 may manage an entity name ontology plane 330 generated based on intra-plane relation information of an entity name defining a relationship between a plurality of entity name nodes. The entity name management unit 130 may manage the entity name ontology plane 330 based on the intra-plane relation information of an entity name comprising at least one transition probability information of an entity name node, use keywords similarity information of an entity name node and simultaneous entrance probability information of an entity name node, which can define a relationship between a plurality of entity name nodes.

The inter-plane relation management unit 140 may construct an inter-plane relation based on inter-plane relation information defining a relationship between the domain ontology plane 310, the main act ontology plane 320 and the entity name ontology plane 330.

More specifically, the inter-plane relation management unit 140 may construct the inter-plane relation based on the inter-plane relation information comprising inter-plane probability information indicating mutual relations between a plurality of domain nodes, a plurality of main act nodes and a plurality of entity name nodes.

Components of the apparatus 100 for constructing an ontology for a dialogue system according to an example embodiment of the present invention have been arranged and described above, but at least two of the components may be integrated into a single component, or a single component may be divided into a plurality of components to perform corresponding functions. Even cases in which each component is integrated or divided are included within the scope of the present invention.

The computer-readable recording medium includes all types of recording devices in which data that can be read by a computer system can be stored. In addition, the computer-readable recording medium may be distributed among computer systems connected via a network, so that the computer-readable program or code may be stored and executed in a decentralized fashion.

The method and the apparatus for constructing an ontology for a dialogue system according to an example embodiment of the present invention can construct multiple ontology planes and discriminate components of dialogue frames such as a domain, a main act and an entity name.

Also, an effective system response can be performed by discriminating dialogue frames exactly using the multiple ontology planes.

While the example embodiments of the present invention and their advantages have been described in detail, it should be understood that various changes, substitutions and alterations may be made herein without departing from the scope of the invention.

What is claimed is:

1. A method for constructing an ontology for a dialogue system performed by an ontology construction apparatus, the method comprising:
generating a domain ontology plane based on intra-plane relation information of a domain defining a relationship between a plurality of domain nodes;
generating a main act ontology plane based on intra-plane relation information of a main act defining a relationship between a plurality of main act nodes; and
generating an entity name ontology plane based on intra-plane relation information of an entity name defining a relationship between a plurality of entity name nodes.

2. The method of claim 1, further comprising constructing an inter-plane relation based on inter-plane relation information defining a relationship between the domain ontology plane, the main act ontology plane and the entity name ontology plane.

3. The method of claim 2, wherein in the constructing of an inter-plane relation,
the inter-plane relation is constructed based on the inter-plane relation information comprising inter-plane probability information indicating mutual relations between the plurality of domain nodes, the plurality of main act nodes and the plurality of entity name nodes.

4. The method of claim 1, wherein in the generating of a domain ontology plane,
the domain ontology plane is generated based on the intra-plane relation information of a domain comprising at least one transition probability information of a domain node, use keywords similarity information of a domain node and layer information of a domain node, which can define a relationship between the plurality of domain nodes.

5. The method of claim 1, wherein in the generating of a main act ontology plane,
the main act ontology plane is generated based on the intra-plane relation information of a main act comprising at least one transition probability information of a main act node, use keywords similarity information of a main act node and performance order information of a main act node, which can define a relationship between the plurality of main act nodes.

6. The method of claim 1, wherein in the generating of an entity name ontology plane,
the entity name ontology plane is generated based on the intra-plane relation information of an entity name comprising at least one transition probability information of an entity name node, use keywords similarity information of an entity name node and simultaneous entrance probability information of an entity name node, which can define a relationship between the plurality of entity name nodes.

7. An apparatus for constructing an ontology for a dialogue system comprising:
a domain management unit configured to manage a domain ontology plane generated based on intra-plane relation information of a domain defining a relationship between a plurality of domain nodes;
a main act management unit configured to manage a main act ontology plane generated based on intra-plane relation information of a main act defining a relationship between a plurality of main act nodes; and
an entity name management unit configured to manage an entity name ontology plane generated based on intra-plane relation information of an entity name defining a relationship between a plurality of entity name nodes.

8. The apparatus of claim 7, further comprising an inter-plane relation management unit configured to construct an inter-plane relation based on inter-plane relation information defining a relationship between the domain ontology plane, the main act ontology plane and the entity name ontology plane.

9. The apparatus of claim 8, wherein the inter-plane relation management unit constructs the inter-plane relation based on the inter-plane relation information comprising inter-plane probability information indicating mutual relations between the plurality of domain nodes, the plurality of main act nodes and the plurality of entity name nodes.

10. The apparatus of claim 7, wherein the domain management unit manages the domain ontology plane based on the intra-plane relation information of a domain comprising at least one transition probability information of a domain node, use keywords similarity information of a domain node and layer information of a domain node, which can define a relationship between the plurality of domain nodes.

11. The apparatus of claim 7, wherein the main act management unit manages the main act ontology plane based on the intra-plane relation information of a main act comprising at least one transition probability information of a main act node, use keywords similarity information of a main act node and performance order information of a main act node, which can define a relationship between the plurality of main act nodes.

12. The apparatus of claim 7, wherein the entity name management unit manages the entity name ontology plane based on the intra-plane relation information of the entity name comprising at least one transition probability information of an entity name node, use keywords similarity information of an entity name node and simultaneous entrance probability information of an entity name node, which can define a relationship between the plurality of entity name nodes.
